(19) United States
(12) Patent Application Publication
(10) Pub. No.: US 2020/0254569 A1
(43) Pub. Date: Aug. 13, 2020

(54) SURFACE MODIFICATION BY LOCALIZED LASER EXPOSURE

(71) Applicant: Corning Incorporated, Corning, NY (US)

(72) Inventors: Xinghua Li, Horseheads, NY (US); Seth Thomas Nickerson, Corning, NY (US); Huthavahana Kuchibhotla Sarma, San Jose, CA (US)

(21) Appl. No.: 16/787,843

(22) Filed: Feb. 11, 2020

Related U.S. Application Data
(60) Provisional application No. 62/803,688, filed on Feb. 11, 2019.

(51) Int. Cl. B23K 26/354; B23K 26/352; B23K 26/08; B23K 26/70

(52) U.S. Cl. CPC B23K 26/354; B23K 26/355; B23K 2103/52; B23K 26/70; B23K 26/0823

(57) ABSTRACT

The system may include a rotatable stage configured to support a ceramic substrate and an energy emitter positioned adjacent to the ceramic substrate. In some cases, the energy emitter may be configured to transmit an energy beam toward one or more outer faces of the ceramic substrate so as to modify a surface roughness of the one or more outer faces. In some cases, the method may include identifying a target surface roughness based at least in part on a target friction coefficient, and identifying a target surface area of the ceramic substrate, transmitting an energy beam toward the surface of the ceramic substrate via an energy emitter positioned adjacent to the ceramic substrate, and heating the target surface area of the surface of the ceramic substrate until a surface roughness of the target surface area is within a predetermined range of the target surface roughness.

This application claims the benefit of priority under 35 U.S.C. § 119 of U.S. Provisional Application No. 62/803,688 filed on Feb. 11, 2019, the content of which is incorporated herein by reference in its entirety.

### BACKGROUND

The following relates generally to surface modification by localized laser exposure.

Catalytic converters may be widely used to develop emission control systems in various applications such as vehicle and engine manufacturing, non-road engines, and other machine manufacturing. In some cases, catalytic converters may convert toxic gases and pollutants in exhaust gas into less-toxic pollutants by catalyzing a redox reaction. In catalytic converters or in addition to catalytic converters, substrate and filtration products may be implemented to reduce emissions, optimize power, and improve fuel economy. For example, a substrate may be coated with a metal catalyst to convert gases such as oxides of nitrogen, carbon monoxide, and hydrocarbons to gases such as nitrogen, carbon dioxide, and water vapor.

Some types of substrates may be designed to be compatible with the catalytic converter according to shape, size, and composition. For example, an ultrathin-wall substrate may reduce the amount of metal catalysts coating the substrate because of the high surface area of the substrate. In some cases, the outer surface of the substrate may be used to support or contain the substrate within the catalytic converter.

### SUMMARY

The described features generally relate to methods, systems, devices, or apparatuses that support surface modification by localized laser exposure. A method for modifying a surface of a ceramic substrate is described. The method may include identifying a target surface roughness based at least in part on a target friction coefficient, identifying a target surface area of the ceramic substrate to be modified to the target surface roughness, transmitting an energy beam toward the surface of the ceramic substrate via an energy emitter positioned adjacent to the ceramic substrate, and heating the target surface area of the surface of the ceramic substrate until a surface roughness of the target surface area is within a predetermined range of the target surface roughness.

Some examples of the method described herein may further include measuring a friction coefficient of the surface of the ceramic substrate after heating the target surface area, adjusting one or more beam configuration parameters for the energy beam based at least in part on the measured friction coefficient and the target friction coefficient, and transmitting the energy beam based at least in part on the adjusted one or more beam configuration parameters.

In some examples, heating the target surface area may include melting at least a portion of the target surface area until the surface roughness of the target surface area is within the predetermined range of the target surface roughness. Some examples of the method described herein may further include identifying a depth of penetration of the surface of the ceramic substrate and transmitting the energy beam based at least in part on the depth of penetration. Some examples of the method described herein may further include identifying a surface pattern or texture for the surface of the ceramic substrate and transmitting the energy beam based at least in part on the surface pattern or texture.

Some examples of the method described herein may further include determining one or more defects in the surface of the ceramic substrate, adjusting the target roughness and the target surface area based at least in part on the one or more defects, and heating the adjusted target surface area of the surface of the ceramic substrate until the surface roughness of the adjusted target surface area is within a correction range associated with the adjusted target roughness. Some examples of the method described herein may further include rotating a stage supporting the ceramic substrate based at least in part on the target roughness and the target surface area.

In some examples, transmitting the energy beam may include identifying a beam configuration based at least in part on a set of texture characteristics and transmitting a line laser beam or a point source laser beam in accordance with the beam configuration. Some examples of the method described herein may further include setting a beam configuration for the energy beam according to the target surface roughness and the target surface area and transmitting the energy beam based at least in part on the beam configuration.

Systems are also described. In some examples, the system may include a rotatable stage having a portion configured to support a ceramic substrate having two opposing ends and one or more outer faces extending between the two opposing ends and an energy emitter positioned adjacent to the ceramic substrate supported by the rotatable stage, the energy emitter configured to transmit an energy beam toward the one or more outer faces of the ceramic substrate so as to modify a surface roughness of the one or more outer faces in accordance with at least a target surface area and a target surface roughness based at least in part on a target friction coefficient.

Some examples of the system described herein may further include the ceramic substrate comprising a porous ceramic material and positioned on the rotatable stage, wherein the surface roughness of the one or more outer faces is different from the target surface roughness. In some cases, a total surface area of the one or more outer faces is greater than the target surface area. Some examples of the system described herein may further include a controller to control transmission of the energy beam via the energy emitter according to a set of surface processing parameters comprising at least the target surface roughness and the target surface area.

In some examples, the controller may be configured to set a beam configuration for the energy beam, the beam configuration based at least in part on the target surface roughness, the target surface area, and a surface pattern and transmit the energy beam according to the beam configuration so as to modify the one or more outer faces of the ceramic substrate with the surface pattern. In some examples, the controller may be configured to set a beam configuration for the energy beam, the beam configuration based at least in part on the target surface roughness, the target surface area, and a surface texture and transmit the energy beam according to the beam configuration so as to modify the one or more outer faces of the ceramic substrate with the surface texture.

In some examples, the controller may be configured to set a beam configuration for the energy beam, the beam configuration based at least in part on the target surface roughness, the target surface area, a beam power, and a beam exposure duration and transmit the energy beam according to the beam configuration so as to modify the one or more outer faces of the ceramic substrate with at least the target surface roughness and the target surface area for the beam exposure duration. In some examples, the controller may be configured to set a beam configuration for the energy beam, the beam configuration based at least in part on one or more of the target surface roughness, the target surface area, and the target friction coefficient and transmit the energy beam according to the beam configuration so as to modify the one or more outer faces of the ceramic substrate with the target friction coefficient.

In some examples, the controller may be configured to set a beam configuration for the energy beam, the beam configuration based at least in part on one or more defects of the ceramic substrate and transmit the energy beam according to the beam configuration so as to correct the one or more defects in the one or more outer faces of the ceramic substrate. Some examples of the system described herein may further include a rotation controller configured to rotate the ceramic substrate via the rotatable stage according to a set of surface processing parameters comprising at least the target surface roughness and the target surface area. In some examples, the energy emitter may comprise a laser source where the laser source may be configured to transmit a line laser beam or a point source laser beam in accordance with a beam configuration. In some examples, the beam configuration may be associated with a surface pattern or a surface texture for the one or more outer faces of the ceramic substrate.

### BRIEF DESCRIPTION OF THE DRAWINGS

FIG. 1 illustrates an example emissions system that supports surface modification by localized laser exposure in accordance with examples of the present disclosure.

FIG. 2 illustrates an example system that supports surface modification by localized laser exposure in accordance with examples of the present disclosure.

FIG. 3A illustrates an example point source laser beam system that supports surface modification by localized laser exposure in accordance with examples of the present disclosure.

FIG. 3B illustrates an example line laser beam system that supports surface modification by localized laser exposure in accordance with examples of the present disclosure.

FIG. 3C illustrates an example laser beam system that supports surface modification by localized laser exposure in accordance with examples of the present disclosure.

FIG. 4A illustrates an example surface pattern or texture of a ceramic substrate that supports surface modification by localized laser exposure in accordance with examples of the present disclosure.

FIG. 4B illustrates an example surface pattern or texture of a ceramic substrate that supports surface modification by localized laser exposure in accordance with examples of the present disclosure.

FIG. 5A illustrates an example surface defect of a ceramic substrate that supports surface modification by localized laser exposure in accordance with examples of the present disclosure.

FIG. 5B illustrates an example surface defect correction of a ceramic substrate that supports surface modification by localized laser exposure in accordance with examples of the present disclosure.

FIG. 6 illustrates an example system that supports surface modification by localized laser exposure in accordance with examples of the present disclosure.

FIG. 7 illustrates an example system that supports surface modification by localized laser exposure in accordance with examples of the present disclosure.

FIG. 8 illustrates a method that supports surface modification by localized laser exposure in accordance with examples of the present disclosure.

FIG. 9 illustrates a method that supports surface modification by localized laser exposure in accordance with examples of the present disclosure.

### DETAILED DESCRIPTION

Substrates or honeycomb filters may be used to trap particulates (e.g., toxins) within an emission control system (a catalytic converter system, a emission filtration system, etc.). The surface roughness of an outer surface of the substrate may affect a substrate's position within a housing of the emission control system. For example, as the radial pressure on the housing varies (due to temperature change, exhaust flow, etc.), the frictional gripping strength between the outer surface of the substrate and the catalytic converter also varies and a higher coefficient of friction associated with the outer surface may be capable of holding the substrate within the housing during these variances. To modify (e.g., increase or decrease) the coefficient of friction associated with the outer surface of the substrate, the roughness of the outer surface of the substrate may be modified through localized energy exposure. In some aspects, transmitting an energy beam (e.g., a laser beam) at the outer surface of the substrate may increase the surface roughness (e.g., through ablating, heating, and/or melting of the outer surface of the substrate). Ablating described herein may be represented using any of a variety of different heating and/or melting techniques. In some cases, the energy beam may be represented as a laser beam. For example, heating the outer surface of the substrate until the surface roughness is within a predetermined range of a target surface roughness (e.g., associated with a given coefficient of friction), which may increase the gripping force between the outer surface of the substrate and the housing. In some cases, this may provide limited or no movement of the substrate within the housing. When a substrate is stationary (or is limited in movement) within the housing, the conversion efficiency of the toxic gases and pollutants in into less-toxic pollutants may increase.

Achieving the target surface roughness of the outer surface of the substrate may be realized using an energy emitter, a beam deflection system, and a stage (e.g., a rotatable stage, a conveyor belt, a roller, a surface) to support the substrate. For example, the substrate may be supported on a stage positioned adjacent to the energy emitter. In such a case, the energy emitter may transmit an energy beam towards the outer surface of the substrate to modify the surface roughness of the substrate. The stage may be a rotatable stage configured to rotate the substrate or a translational stage (e.g., a conveyor belt) configured to move the substrate along a linear path. Alternatively, the energy emitter may be configured to be movable with respect to the substrate using a beam deflection/scanning system. For instance, the energy beam may capable of being directed in multiple different directions or the energy emitter may be coupled to system capable of moving the energy emitter with respect to the outer surface of the substrate, or both. In some cases, the energy emitter may emit a line laser beam or a point source laser beam to heat (e.g., ablate) the surface of the substrate. In some cases, multiple emitters or multiple beams may split from a single emitter and may be used to ablate or heat the surface of the substrate at different spatial positions.

According to some aspects, the energy beam may be transmitted according to a beam configuration. For example, the beam configuration may be based on a set of texture characteristics of the outer surface of the substrate, a target surface roughness of the outer surface of the substrate, a target surface area of the substrate, a surface pattern or texture of the substrate, a depth of penetration, or a combination thereof.

In some instances, the surface of the substrate may be modified by identifying the target roughness and a target surface area of the substrate. A target friction coefficient for the surface of the substrate may be identified, and the target surface roughness and the target surface area may be determined based on the target friction coefficient. If the measured friction coefficient of the surface of the substrate is determined to be different than the target friction coefficient, then the energy emitter may emit the energy beam to the surface of the substrate. In such a case, the friction coefficient of the surface of the substrate may be adjusted to the target friction coefficient.

Modifying the surface roughness of the substrate may enable the roughness of the outer surface to increase without affecting the manufacturing process of the substrate. In some cases, modifying the surface texture of the substrate by adjusting the surface roughness of the substrate may create patterns in the outer surface of the substrate. For example, the texture or patterns in the surface of the substrate may strengthen the material of the substrate. In some cases, the mechanical strength or damage resistance may increase through the modification of the outer surface of a substrate. This may lead to increase chip resistance, reduced wear rate, or may help meet erosion resistance targets. Achieving the target surface roughness of the outer surface of the substrate may decrease manufacturing cost or efficiently reduce emissions in exhaust systems.

Features of the disclosure introduced above are further described below in the context of surface modification by localized laser exposure. Surface modification of the substrate are illustrated and depicted in the context of localized laser exposure techniques. These and other features of the disclosure are further illustrated by and described with reference to apparatus diagrams, system diagrams, and flowcharts that relate to surface modification by localized laser exposure.

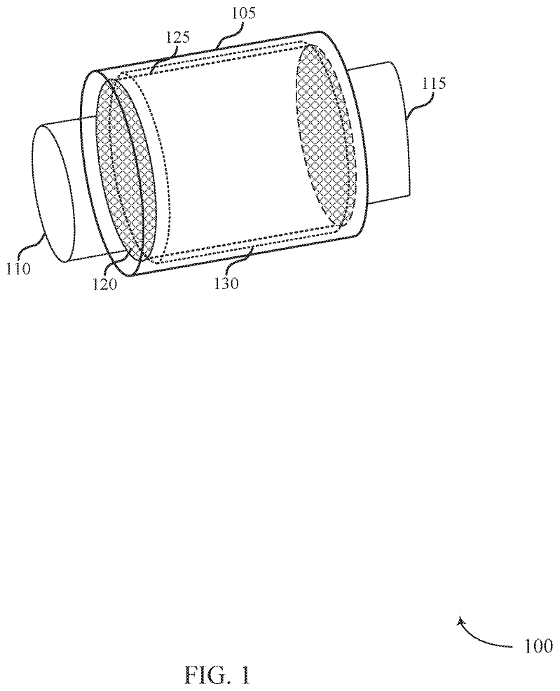

FIG. 1 illustrates an example emissions system 100 that supports surface modification by localized laser exposure in accordance with various examples of the present disclosure. Emissions system 100 may include an outer shell 105, an inlet 110, and an outlet 115. Emissions system 100 may also include a substrate 120 housed within the outer shell 105, for example, and the substrate 120 may include an outer surface 125. The emissions system 100 may also include a sleeve 130 (e.g., a fabric or other material) positioned between the outer surface 125 and the outer shell 105.

The emissions system 100 may be an example of an exhaust emission control device that converts toxic gases and pollutants in exhaust gas into less-toxic pollutants by catalyzing a redox reaction (e.g., a catalytic converter). The emissions system 100 may be implemented within internal combustion engines fueled by either gasoline or diesel. For example, the emissions system 100 may be implemented in automobiles, electrical generators, forklifts, mining equipment, locomotives, motorcycles, etc. In some cases, the emissions system 100 may be implemented in lean-burn engines such as kerosene heaters, stoves, or the like.

In some aspects, the emissions system 100 may transform gas and pollutants that enter through inlet 110 into less-toxic pollutants that exit though outlet 115. For example, gases such as oxides of nitrogen, carbon monoxide, and hydrocarbons may enter through inlet 110 and may exit the emissions system 100 as gases such as nitrogen, carbon dioxide, and water vapor. In such a case, an oxidation and reduction reaction (e.g., redox reaction) may occur within the emissions system 100 to convert the toxic gases (e.g., emissions) into less harmful gases for the environment. The emissions system 100 may reduce emissions and increase the fuel economy.

To convert the toxic gases into less-toxic pollutants, the emissions system 100 may include the substrate 120. The substrate 120 may be an example of a honeycomb filter made of a ceramic material that in some cases may act as a carrier of a metal catalyst. For example, an interior surface of the substrate 120 may be coated with the metal catalyst. In that case, the toxic gases may flow into the emissions system 100 through inlet 110, react with the metal catalyst coated on the interior surface of the substrate 120, and exit the emissions system 100 through outlet 115 as converted less-toxic gases. In other examples, the substrate 120 may include multiple honeycomb layers configured to trap particulates of exhaust gas passing through the substrate 120.

The substrate 120 may be encased within the outer shell 105. For example, the outer surface 125 may abut an inside surface (e.g., mat material) of the outer shell 105. In some cases, the substrate 120 may be encased within the outer shell 105 by establishing a frictional barrier and maintaining radial pressure between the outer surface 125 of the substrate 120 and the inner surface of the outer shell 105 or the sleeve 130. In some examples, if the radial pressure is less than a threshold to maintain the substrate 120 within the outer shell 105, the substrate 120 may move within the outer shell 105, which may result in inefficient conversion or particulate retention. In other examples, if the radial pressure is more than a threshold to maintain the substrate 120 within the outer shell, 105, the substrate 120 may be damaged during use (e.g., the outer surface 125 may incur one or more defects or the substrate 120 may break).

The outer surface 125 of the substrate 120 may be heated (e.g., ablated) to increase a surface roughness of the outer surface 125. Increasing the surface roughness of the outer surface 125 may establish a frictional barrier between the outer surface 125 of the substrate 120 and the inside surface of the catalytic converter. Therefore, a lower radial pressure may be applied while maintaining a gripping strength between the outer surface 125 of the substrate 120 and the inner surface of the outer shell 105. In such a case, increasing the surface roughness of the outer surface 125 may reduce a high back pressure when there may be resistance to the flow of gases through the emissions system 100.

In some cases, the substrate 120 may increase the conversion efficiency of the emissions system 100. For example, the substrate 120 may allow the emissions system 100 to effectively convert undesirable exhaust elements into less harmful emissions. In some examples the substrate 120 may allow for a high surface area ceramic substrate to be used close to an engine to optimize the performance of a system where space is limited and emissions system configurations may be challenging.

In some examples, it may be difficult to manufacture the substrate 120 for a particular size or shape or with an outer surface 125 of a particular roughness (e.g., associated with a given coefficient of friction). In such instances, increasing the surface roughness of the outer surface 125 contacting the inner surface of the outer shell 105 may be beneficial. In some cases, the substrate 120 may be more compatible for applications with space limitations, various temperature fluctuations and operating environments, or a combination thereof. The substrate 120 may include a material that may vary with temperature, include a resistance to thermal shock, and may vary strength and capability with a particular catalyst coated on the interior surface of the substrate 120.

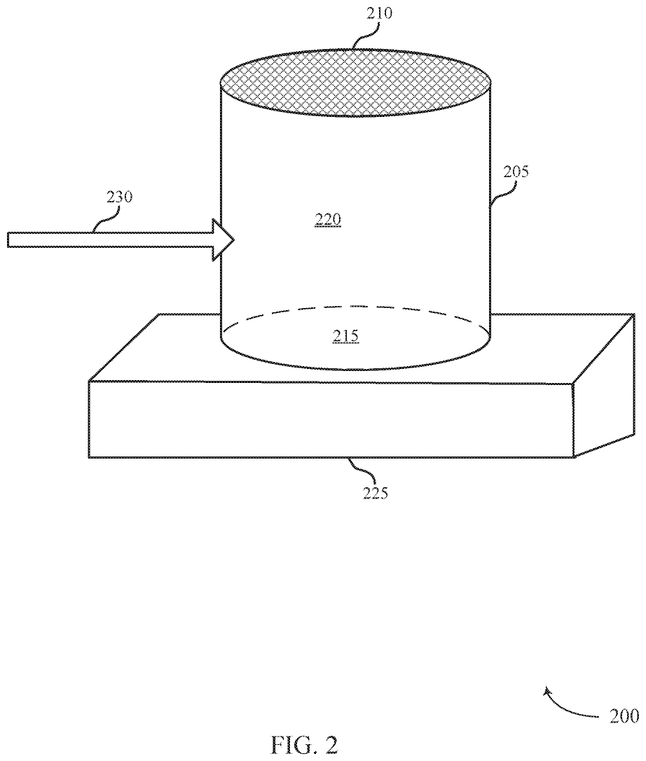

FIG. 2 illustrates an example system 200 that supports surface modification by localized laser exposure in accordance with examples of the present disclosure. The system 200 may include a substrate 205. The substrate 205 may include top surface 210 and bottom surface 215 opposite the top surface 210. The substrate 205 may also include an outer surface 220 that extends between the top surface 210 and the bottom surface 215 of the substrate 205. The substrate 205 and the outer surface 220 may be an example of the substrate and the outer surface as described in reference to FIG. 1. The system 200 may also include a stage 225 and an energy beam 230. Though shown as cylindrical, the substrate 205 may be any shape.

In some cases, the outer surface 220 of the substrate 205 may be modified in order to aide in securing the substrate 205 within a housing of an emissions system. For example, a target surface area and a target surface roughness of the substrate 205 may be identified or determined based on characteristics of the housing (material composition, size, etc.), the sleeve (material composition, coefficient of friction, size, etc.), or the emissions system (e.g., operating temperatures, exhaust flow rates, vehicle type). In some examples, a target friction coefficient (e.g., coefficient of friction) for the outer surface 220 of the substrate 205 may be identified to determine the target roughness and the target surface area. For instance, the coefficient of friction may be related to the shear strength for the system by:

τᵤ=μₛ·Pᵣ (1)

That is, shear strength (τᵤ) may be equal to the product of the coefficient of friction (μₛ) and the pressure (Pᵣ). The pressure may be an example of the isostatic strength of the system. In conventional systems, the pressure may be manipulated to affect the shear strength. However, in this case, the coefficient of friction may be adjusted to affect the shear strength of the system. In order to adjust the coefficient of friction, the energy beam 230 may be transmitted towards the outer surface 220 of the substrate 205. In some cases, one or more energy beams 230 (e.g., an array of energy beams 230) may be transmitted towards the outer surface 220 of the substrate. In such instances, the target surface area of the outer surface 220 of the substrate may be heated or ablated until the surface roughness of the target surface area is within a predetermined range of the target surface roughness. In some examples, the target surface roughness and the target surface area may be determined based on the coefficient of friction. In some examples, the target surface roughness may be between 0.5 and 50 microns roughness average (Ra).

In some cases, the coefficient of friction of the outer surface 220 of the substrate 205 may be measured after heating the target surface area of the outer surface 220. If the measured coefficient of friction is different than the target coefficient of friction, a parameter (e.g., intensity, beam size, pitch, direction) associated with the energy beam 230 may be adjusted, and the energy beam 230 with the adjusted parameter may be transmitted to the target surface area of the outer surface 220.

The energy beam 230 may be an example of a laser beam configured to ablate and/or melt at least a portion of the target surface area of the outer surface 220 until the surface roughness of the target surface area is within the predetermined range of the target surface roughness. For example, a high power laser may locally treat (and melt if desired) the surface of the substrate 205 through thermal properties associated with the lasers. In some cases, the energy beam 230 may be transmitted to the outer surface 220 of the substrate 205 in multiple configurations to create varying patterns and textures on the outer surface 220 of the substrate 205. Further, the energy beam 230 may be used to adjust the surface porosity of the substrate 205. By modifying the outer surface 220 of the substrate 205, the porosity characteristics of the outer surface 220 may change. In some examples, the porosity of the outer surface 220 may increase, allowing for more flow through the outer surface 220. In other cases, the porosity of the outer surface may decrease, allowing for less flow through the outer surface 220. Reduction of surface porosity via techniques herein may be beneficial in preventing leakage of exhaust flow through the substrate 205 or enhanced particulate trapping within the substrate 205.

In some instances, the substrate 205 may be mounted on a stage 225. The stage 225 may be an example of a translational stage (e.g., conveyer belt) configured to move the substrate 205 in front of the energy beam 230 in a linear fashion. In some cases, the stage 225 may be an example of a rotational stage configured to rotate the substrate 205 in front of the energy beam 230. Additionally or alternatively, the energy beam 230 may be configured to move relative to the substrate 205 using a fast laser beam deflection device such as a galvanometric scanner, a polygon scanner, an acousto-optical deflector, or a piezoelectric deflection mirror. The energy beam 230 may melt a portion of the outer surface 220 of the substrate 205 in a controlled manner by controlling the one or more parameters associated with the energy beam 230 (e.g., duration, speed, power, energy beam configuration, etc.). For example, the processing parameters, the exposure duration, surface characteristics (such as roughness), depth of penetration, patterning, or a combination thereof may be manipulated.

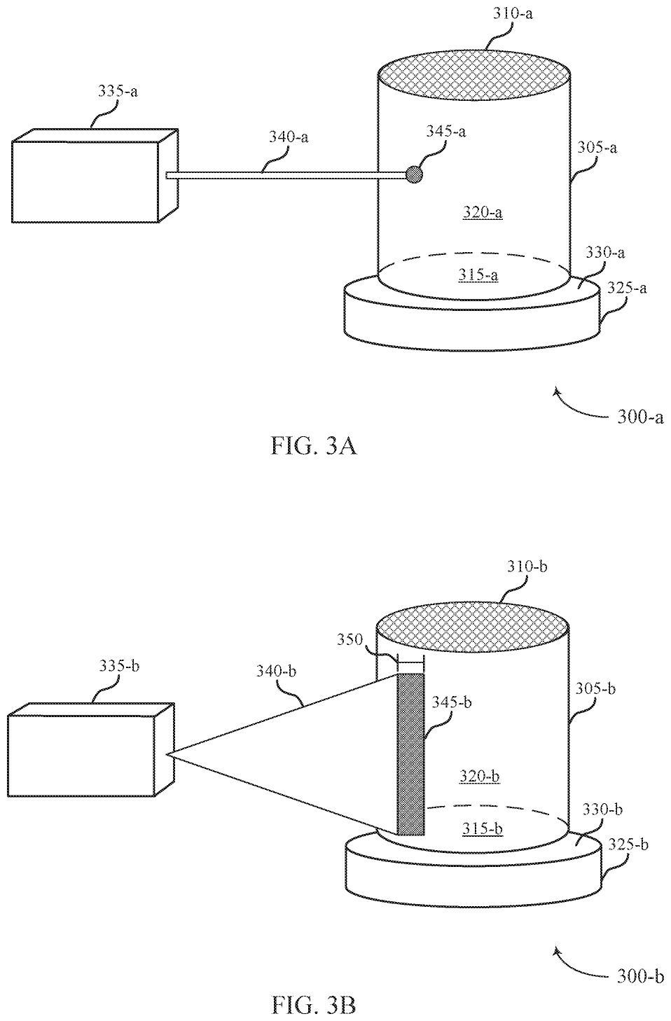

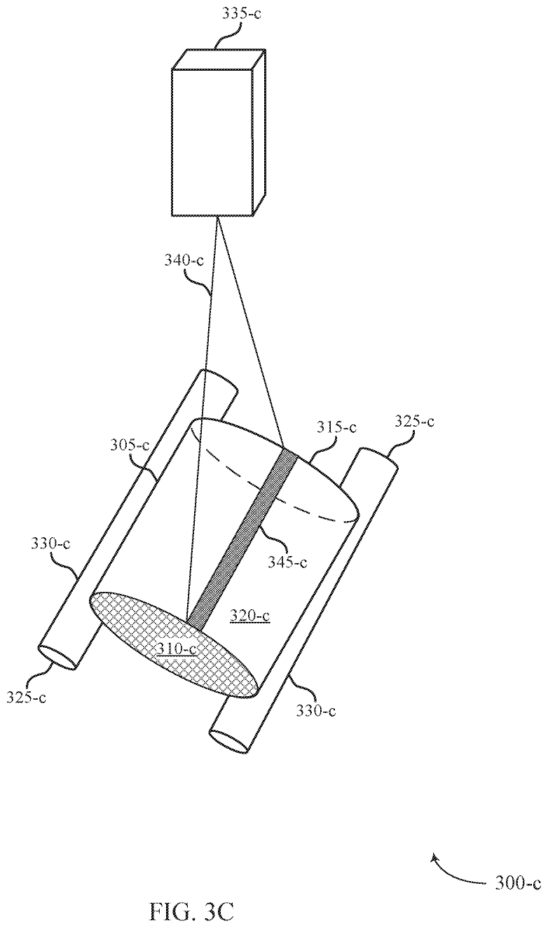

FIG. 3A illustrates an example point source laser beam system 300-a that supports surface modification by localized laser exposure in accordance with examples of the present disclosure. The point source laser beam system 300-a may include a substrate 305-a. The substrate 305-a may include a top surface 310-a and a bottom surface 315-a opposite the top surface 310-a. The substrate 305-a may include an outer surface 320-a that extends between the top surface 310-a and the bottom surface 315-a of the substrate 305-a. The point source laser beam system 300-a may also include a stage 325-a including an upper surface 330-a. Additionally, the point source laser beam system 300-a may include an energy emitter 335-a with an energy beam 340-a toward target surface area 345-a. The substrate 305-a, top surface 310-a, bottom surface 315-a, outer surface 320-a, stage 325-a, and energy beam 340-a may be an example of the substrate, top surface, bottom surface, outer surface, stage, and energy beam as described in reference to FIGS. 1 and 2. In an exemplary configuration, the energy beam 340-a may be rastered vertically while the stage 325-a may be rotated around a vertical axis.

The energy emitter 335-a may be configured to transmit the energy beam 340-a towards the outer surface 320-a of the substrate 305-a so as to modify the surface roughness of the target surface area 345-a. In some cases, the point source laser beam system 300-a may be an example of a point source laser treatment. For example, the energy emitter 335-a may emit an energy beam 340-a (e.g., point source laser) towards the target surface area 345-a of the outer surface 320-a. The energy beam 340-a may be focused using an optical lens or lenses prior to incident on the target surface area 345-a. The focus of energy beam 340-a may be on or in close proximity to target surface area 345-a. An auto-focusing system may be used to maintain constant focus with respect to target surface area 345-a. Additionally or alternatively, a laser beam with long depth of focus (such as a Bessel beam) may be used to compensate for slight variations of the laser focus with respect to target surface area 345-a. In some cases, the target surface area 345-a may be less than a total surface area of the outer surface 320-a of the substrate 305-a.

The energy emitter 335-a may be positioned adjacent to the substrate 305-a. The energy beam 340-a move to etch patterns (e.g., create a raster) in the target surface area 345-a. In some cases, the stage 325-a supporting the substrate 305-a may rotate or translate to move the substrate 305-a and direct the energy beam 340-a towards the identified target surface area 345-a. In some examples, the energy beam 340-a may be transmitted according to a beam configuration based on a set of texture characteristics of the outer surface 320-a of the substrate 305-a, a surface pattern of the target surface area 345-a, a surface texture of the target surface area 345-a, or a combination thereof. In such a case, the energy emitter 335-a may transmit the energy beam 340-a according to the beam configuration.

In some aspects, the energy emitter 335-a may transmit the energy beam 340-a according to the target surface area 345-a and the target surface roughness (which may be based on a target friction coefficient). For example, a processing parameter (e.g., duration, power, surface pattern) associated with the energy emitter 335-a may be adjusted according to the target surface roughness and the target surface area 345-a. In such a case, the energy emitter 335-a may include a controller to control the transmission of the energy beam 340-a according to the set of processing parameters (e.g., surface processing parameters). The set of processing parameters may include, but are not limited to, beam power, beam frequency, beam exposure duration, target surface roughness, target surface area 345-a, or a combination thereof.

In some instances, the energy beam 340-a may be transmitted based on a target coefficient of friction. For example, the energy emitter 335-a may transmit the energy beam 340-a so as to modify the outer surface 320-a to the target coefficient of friction. Those skilled in the art will recognize that, in some cases, operations described with a single exposure to the energy beam 340-a and/or heating step may be performed with separate exposure operations and vice versa.

FIG. 3B illustrates an example line source laser beam system 300-b that supports surface modification by localized laser exposure in accordance with examples of the present disclosure. The line source laser beam system 300-b may include a substrate 305-b. The substrate 305-b may include top surface 310-b and bottom surface 315-b opposite the top surface 310-b. The substrate 305-b may also include an outer surface 320-b that circumscribes the substrate 305-b. The line source laser beam system 300-b may also include a stage 325-b including an upper surface 330-b. Additionally, the line source laser beam system 300-b may include an energy emitter 335-b with an energy beam 340-b directed toward target surface area 345-b. The energy beam 340-b may be a line source laser beam that is achieved by rapidly scanning a pulsed laser beam. The substrate 305-b, top surface 310-b, bottom surface 315-b, outer surface 320-b, stage 325-b, and energy beam 340-b may be an example of the substrate, top surface, bottom surface, outer surface, stage, and energy beam as described in reference to FIGS. 1 and 2.

The energy emitter 335-b may be configured to transmit the energy beam 340-b towards the outer surface 320-b of the substrate 305-b so as to modify the surface roughness of the target surface area 345-b. In some cases, the line source laser beam system 300-b may be an example of a line laser treatment. For example, the energy emitter 335-b may emit an energy beam 340-b (e.g., a line laser) towards the target surface area 345-b of the outer surface 320-b. In some cases, the target surface area 345-b may be less than a total surface area of the outer surface 320-b of the substrate 305-b.

The energy emitter 335-b may be positioned adjacent to the substrate 305-b. The energy beam 340-b may raster and move around to etch patterns in the target surface area 345-b. In some cases, the stage 325-b supporting the substrate 305-b may rotate or translate to move the energy beam 340-b towards the identified target surface area 345-b. Additionally or alternatively, the energy emitter 335-b may be configured to move relative to the substrate 305-b. The energy beam 340-b may be transmitted according to a beam configuration based on a set of texture characteristics of the outer surface 320-b of the substrate 305-b, a surface pattern of the target surface area 345-b, a surface texture of the target surface area 345-b, or a combination thereof. In that case, the energy emitter 335-b may transmit the energy beam 340-b according to the beam configuration.

In some cases, the energy emitter 335-b may transmit the energy beam 340-b according to the target surface area 345-b and the target surface roughness (which may be based on a target friction coefficient). For example, a processing parameter (e.g., duration, power, surface pattern) associated with the energy emitter 335-b may be adjusted according to the target surface roughness and the target surface area 345-b. In such a case, the energy emitter 335-b may include a controller to control the transmission of the energy beam 340-b according to the set of processing parameters (e.g., surface processing parameters). The set of processing parameters may include, but are not limited to, beam power, beam frequency, beam exposure duration, target surface roughness, target surface area 345-b, or a combination thereof.

In some cases, the energy beam 340-b may be transmitted according to a depth of penetration 350 of the outer surface 320-b of the substrate 305-b. For example, the depth of penetration 350 may include a depth measured from the outer surface 320-b of the substrate 305-b to an inner surface of the substrate 305-b. The processing parameters as well as laser wavelength associated with the energy emitter 335-b may determine the depth of penetration 350. In some cases, the depth of penetration 350 may be 10-50 micrometers.

In some examples, the energy beam 340-b may be transmitted according to a target coefficient of friction. In that case, the energy emitter 335-b may transmit the energy beam 340-b so as to modify the outer surface 320-b to the target coefficient of friction. Those skilled in the art will recognize that, in some examples, operations described with a single exposure to the energy beam 340-b and/or heating operation may be performed with separate exposure operations and vice versa.

FIG. 3C illustrates an example laser beam system 300-c that supports surface modification by localized laser exposure in accordance with examples of the present disclosure. The laser beam system 300-c may include a substrate 305-c. The substrate 305-c may include top surface 310-c and bottom surface 315-c opposite the top surface 310-c. The substrate 305-c may also include an outer surface 320-c that circumscribes the substrate 305-c. The laser beam system 300-c may also include one or more stages 325-c in the form of rollers, with each stage 325-c having a rolling surface 330-c on which the substrate 305-c may rest. In the example laser beam system 300-c, the substrate 305-c is positioned on its side so that the outer surface 320-c rests on the one or more stages 325-c. Movement of the stages 325-c may result in movement of the substrate 305-c, thus helping to facilitate application of an energy beam 340-c to different portions of the outer surface 320-c of the substrate 305-c. Additionally, the laser beam system 300-c may include an energy emitter 335-c to provide the energy beam 340-c, directed toward the target surface area 345-c. The energy beam 340-c may be a line source laser beam that is achieved by rapidly scanning a pulsed laser beam. The rapidly scanning laser beam may be tracked with respect to stages (e.g., rollers) as the stages themselves move along a linear production line (e.g., during processing-on-the-fly). The substrate 305-c, top surface 310-c, bottom surface 315-c, outer surface 320-c, stages 325-c, and energy beam 340-c may be an example of the substrate, top surface, bottom surface, outer surface, stage, and energy beam as described in reference to FIGS. 1 and 2.

The energy emitter 335-c may be configured to transmit the energy beam 340-c towards the outer surface 320-c of the substrate 305-c so as to modify the surface roughness of the target surface area 345-c. In some cases, the laser beam system 300-c may be an example of a line laser treatment. For example, the energy emitter 335-c may emit an energy beam 340-c (e.g., a line laser) towards the target surface area 345-c of the outer surface 320-c. In some cases, the target surface area 345-c may be less than a total surface area of the outer surface 320-c of the substrate 305-c.

The energy emitter 335-c may be positioned adjacent to the substrate 305-c. The energy beam 340-c may raster and move around to etch patterns in the target surface area 345-c. In some cases, the stages 325-c supporting the substrate 305-c may rotate, translate, or a combination thereof to move the energy beam 340-c towards the identified target surface area 345-c. For example, the stages 325-c may be an example of a roller.

Additionally or alternatively, the energy emitter 335-c may be configured to move relative to the substrate 305-c. The energy beam 340-c may be transmitted according to a beam configuration based on a set of texture characteristics of the outer surface 320-c of the substrate 305-c, a surface pattern of the target surface area 345-c, a surface texture of the target surface area 345-c, or a combination thereof. In that case, the energy emitter 335-c may transmit the energy beam 340-c according to the beam configuration.

In some cases, the energy emitter 335-c may transmit the energy beam 340-c according to the target surface area 345-c and the target surface roughness (which may be based on a target friction coefficient). For example, a processing parameter (e.g., duration, power, surface pattern) associated with the energy emitter 335-c may be adjusted according to the target surface roughness and the target surface area 345-c. In such a case, the energy emitter 335-c may include a controller to control the transmission of the energy beam 340-c according to the set of processing parameters (e.g., surface processing parameters). The set of processing parameters may include, but are not limited to, beam power, beam frequency, beam exposure duration, target surface roughness, target surface area 345-c, or a combination thereof.

In some examples, the energy beam 340-c may be transmitted according to a target coefficient of friction. In that case, the energy emitter 335-c may transmit the energy beam 340-c so as to modify the outer surface 320-c to the target coefficient of friction. Those skilled in the art will recognize that, in some examples, operations described with a single exposure to the energy beam 340-c and/or heating operation may be performed with separate exposure operations and vice versa.

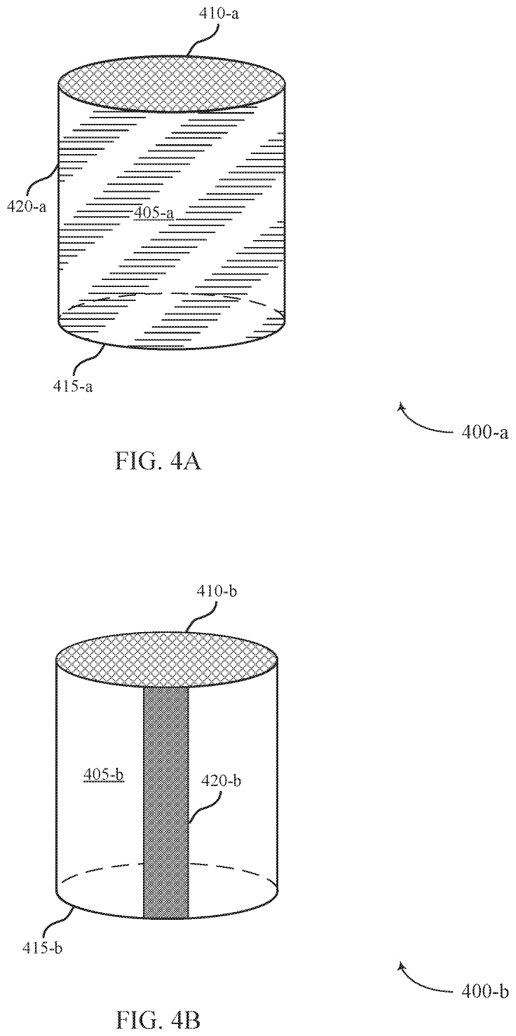

FIG. 4A illustrates an example surface pattern or texture of a substrate 400-a that supports surface modification by localized laser exposure in accordance with examples of the present disclosure. The substrate 400-a may include an outer surface 405-a that extends between a top surface 410-a and a bottom surface 415-a of the substrate 400-a. The substrate 400-a, outer surface 405-a, top surface 410-a, and bottom surface 415-a may be an example of the substrate, the outer surface, the top surface, and the bottom surface as described in reference to FIGS. 1-3. In some cases, substrate 400-a may include surface modification 420-a.

The surface modification 420-a may be an example of a surface pattern or texture of the outer surface 405-a of the substrate 400-a. For example, an energy emitter may transmit an energy beam to form the surface pattern or texture. In some cases, the surface modification 420-a may be applied at an angle relative to an axial direction of the substrate 400-a. In some examples, the surface modification 420-a may include lines periodically spaced, lines evenly or unevenly spaced, or a combination thereof. In some cases, the surface modification 420-a may exhibit a shiny, glassy like appearance even though the surface roughness of the outer surface 405-a may increase. The surface modification 420-a may also prevent a coating bleed through from the outer surface 405-a of the substrate 400-a to an inner surface of the substrate 400-a.

In some cases, the surface modification 420-a may be an example of a barcode label, where the barcode label may include periodic ridges. For example, excess laser exposure may melt grooves or ridges into the outer surface 405-a of the substrate 400-a. In some cases, the surface modification 420-a may provide a barrier (e.g., a foundation) between the outer surface 405-a of the substrate 400-a and the barcode label. For example, creating barcodes may cause chemical transport or diffusion issues in regions around the barcode label (e.g., within a few millimeters of the barcode label) and surface modification 420-a may help prevent these issues and may result in increased readability of the barcode label.

The surface modification 420-a may also be applied to a portion of the outer surface 405-a of the substrate 400-a, or the surface modification 420-a may be applied to the entire outer surface 405-a of the substrate 400-a. Each portion of the outer surface 405-a including surface modification 420-a may be created using different processing settings associated with the energy beam. For example, a visual difference may be present for each portion of the outer surface 405-a including the surface modification.

FIG. 4B illustrates an example surface pattern or texture of a substrate 400-b that supports surface modification by localized laser exposure in accordance with examples of the present disclosure. The substrate 400-b may include an outer surface 405-b that extends between a top surface 410-b and a bottom surface 415-b of the substrate 400-b. The substrate 400-b, outer surface 405-b, top surface 410-b, and bottom surface 415-b may be an example of the substrate, the outer surface, the top surface, and the bottom surface as described in reference to FIGS. 1-3. In some cases, substrate 400-a may include surface modification 420-b.

The surface modification 420-b may be an example of a surface pattern or texture of the outer surface 405-b of the substrate 400-b. For example, an energy emitter may transmit an energy beam to create the surface pattern or texture. In some cases, the surface modification 420-b may extend from the top surface 410-b to the bottom surface 415-b. In some cases, the surface modification 420-b may extend around the circumference of the outer surface 405-b. In some examples, the surface modification 420-b may include one or more blocks of treatment zones (e.g., including surface modification 420-b).

The surface modification 420-b may include a shiny appearance, a dull appearance, an opaque appearance, or a combination thereof. In some cases, the surface modification 420-b may change a color of the outer surface 405-b (e.g., due to an oxidation reaction). For example, the surface modification 420-b may appear black as the product of the titania oxidation state change. That is, the change in oxidation state from the reaction that occurs when the energy beam ablates and/or heats the outer surface 405-b of the substrate 400-a may alter the appearance of the substrate 400-a. The surface modification 420-b also be applied on a portion of the outer surface 405-b of the substrate 400-b, or the surface modification 420-b may be applied to the entire outer surface 405-b of the substrate 400-b.

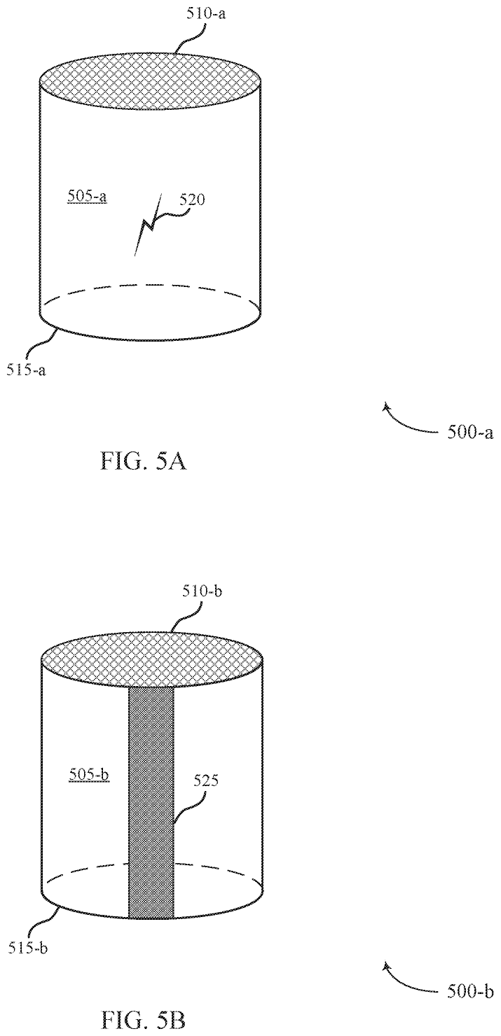

FIG. 5A illustrates an example defect 520 of a substrate 500-a that may be modified by localized laser exposure in accordance with examples of the present disclosure. The substrate 500-a may include top surface 510-a and bottom surface 515-a opposite the top surface 510-a. The substrate 500-a may also include an outer surface 505-a that extends from the bottom surface 515-a to the top surface 510-a of the substrate 500-a. The substrate 500-a, outer surface 505-a, top surface 510-a, and bottom surface 515-a may be an example of the substrate, the outer surface, the top surface, and the bottom surface as described in reference to FIGS. 1-4.

In some cases, the outer surface 505-a may include a defect 520. The defect 520 may be an example of a crack in the porous ceramic material of the substrate 500-a, a tear in the porous ceramic material of the substrate 500-a, a compositional impurity of the substrate 500-a, or the like. In some examples, one or more defects 520 may be present in the outer surface 505-a of the substrate 500-a and an energy emitter may transmit an energy beam according to a beam configuration so as to correct the defect 520 in the outer surface 505-a of the substrate 500-a.

FIG. 5B illustrates an example surface defect correction of a substrate 500-b using localized laser exposure in accordance with examples of the present disclosure. The substrate 500-b may include an outer surface 505-b that circumscribes the substrate 500-b. The substrate 500-b may also include top surface 510-b and bottom surface 515-b opposite the top surface 510-b. In some cases, the substrate 500-b may include a surface modification 525. The substrate 500-b, outer surface 505-b, top surface 510-b, bottom surface 515-b, and surface modification 525 may be an example of the substrate, the outer surface, the top surface, the bottom surface, and surface modification as described in reference to FIGS. 1-4.

To correct a defect (e.g., defect 520 of substrate 500-a in FIG. 5A) in the outer surface 505-b of the substrate 500-b, the energy emitter may set a beam configuration to correct the defect via the surface modification 525. That is, the beam configuration may be based on the defect of the substrate 500-b. In some cases, identifying a target roughness and a target surface area of the substrate 500-b may be based on the location and type of defect. In that case, the energy beam may heat (e.g., ablate) the adjusted target surface area and the adjusted target roughness (e.g., a surface area of the substrate 500-b including the defect) until the surface roughness of the adjusted target surface area is within a correction range.

For example, the energy beam may melt a material into the outer surface 505-b to seal a fissure. In that case, the solid state of the substrate 500-b may liquefy so that the material of the substrate 500-b may move into the defect and bridge a gap between the material around the defect. After the liquified material moves into the defect, the material may solidify to seal the defect with surface modification 525. In some cases, the surface modification 525 may provide a resistance to future defects such as scratches, chipping, and handling damage.

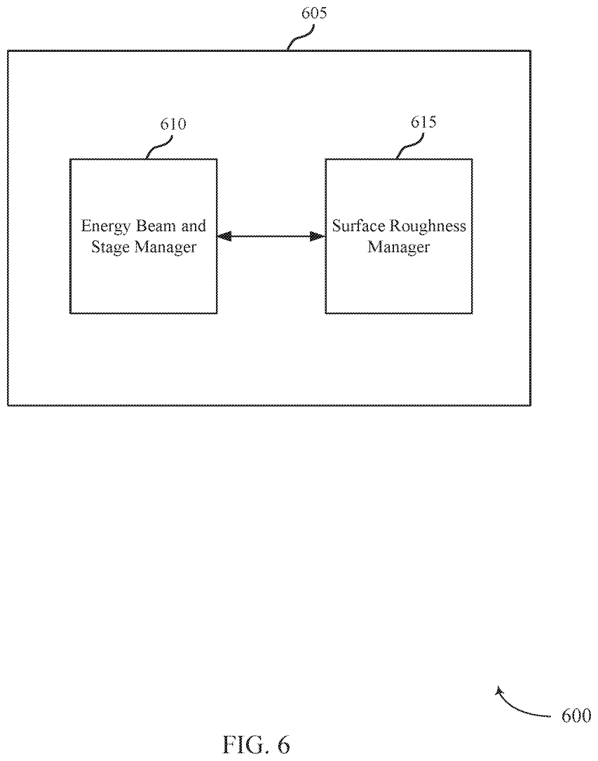

FIG. 6 shows an example block diagram 600 of a system 605 that supports surface modification by localized laser exposure in accordance with examples of the present disclosure. System 605 may be referred to as an electronic apparatus, and may be an example of a component of a controller for surface modification by localized laser exposure.

System 605 may include an energy beam and stage manager 610 and surface roughness manager 615. These components may be in electronic communication with each other and may perform one or more of the functions described herein. These components may also be in electronic communication with other components, both inside and outside of system 605, in addition to components not listed above, via other components, connections, or busses.

The energy beam and stage manager 610 may be configured to transmit an energy beam toward the surface of the ceramic substrate via an energy emitter positioned adjacent to a substrate as described herein. For example, the energy beam and stage manager 610 may be configured to heat the target surface area of the surface of a ceramic substrate until a surface roughness of the target surface area is within a predetermined range of the target surface roughness as described above. In some cases, the energy beam and stage manager 610 may melt at least a portion of the target surface area until the surface roughness of the target surface area is within the predetermined range of the target surface roughness.

In some cases, the energy beam and stage manager 610 may be configured to identify a depth of penetration of the surface of the ceramic substrate and transmit the energy beam based at least in part on the depth of penetration. In some cases, the energy beam and stage manager 610 may be configured to transmit the energy beam based at least in part on the surface pattern or texture.

In some examples, the energy beam and stage manager 610 may adjust one or more beam configuration parameters for the energy beam based at least in part on the measured friction coefficient and a target friction coefficient on which the target surface roughness is based, and transmit the energy beam based at least in part on the adjusted one or more beam configuration parameters.

According to some aspects, the energy beam and stage manager 610 may identify a beam configuration based at least in part on a set of texture characteristics and transmit a line laser beam or a point source laser beam in accordance with the beam configuration. In some examples, the energy beam and stage manager 610 may set a beam configuration for the energy beam according to the target surface roughness and the target surface area and transmit the energy beam based at least in part on the beam configuration.

In some instances, the energy beam and stage manager 610 may set a beam configuration for the energy beam, the beam configuration based at least in part on the target surface roughness, the target surface area, and a surface pattern and transmit the energy beam according to the beam configuration so as to modify the one or more outer faces of the ceramic substrate with the surface pattern. The energy beam and stage manager 610 may also set a beam configuration for the energy beam, the beam configuration based at least in part on the target surface roughness, the target surface area, and a surface texture and transmit the energy beam according to the beam configuration so as to modify the one or more outer faces of the ceramic substrate with the surface texture.

In some examples, the energy beam and stage manager 610 may set a beam configuration for the energy beam, the beam configuration based at least in part on the target surface roughness (which is itself based on a target friction coefficient), the target surface area, a beam power, and a beam exposure duration and transmit the energy beam according to the beam configuration so as to modify the one or more outer faces of the ceramic substrate with at least the target surface roughness and the target surface area for the beam exposure duration. The energy beam and stage manager 610 may also set a beam configuration for the energy beam, the beam configuration based at least in part on one or more of the target surface roughness, the target surface area, and the target friction coefficient and transmit the energy beam according to the beam configuration so as to modify the one or more outer faces of the ceramic substrate with the target friction coefficient.

In some cases, the energy beam and stage manager 610 may set a beam configuration for the energy beam, the beam configuration based at least in part on one or more defects of the ceramic substrate and transmit the energy beam according to the beam configuration so as to correct the one or more defects in the one or more outer faces of the ceramic substrate.

According to some aspects, the energy beam and stage manager 610 may be configured to move an energy emitter or an energy beam from the energy emitter with respect to an outer surface of a substrate. The energy beam and stage manager 610 may be configured to rotate a stage supporting the ceramic substrate based at least in part on the target roughness and the target surface area, as described above.

The energy beam and stage manager 610 may in electronic communication with the surface roughness manager 615. The surface roughness manager 615 may identify a surface pattern or texture for the surface of the ceramic substrate.

For example, the surface roughness manager 615 may determine one or more defects in the surface of the ceramic substrate and adjust the target roughness and the target surface area based at least in part on the one or more defects. In some cases, the energy beam and stage manager 610 may heat the adjusted target surface area of the surface of the ceramic substrate until the surface roughness of the adjusted target surface area is within a correction range associated with the adjusted target roughness.

In some cases, the surface roughness manager 615 may identify a target surface roughness and a target surface area of the ceramic substrate to be modified to the target surface roughness. In some cases, the surface roughness manager 615 may identify a target friction coefficient for the surface of the ceramic substrate and determine the target surface roughness and the target surface area based at least in part on the target friction coefficient. In some examples, the surface roughness manager 615 may measuring a friction coefficient of the surface of the ceramic substrate after heating the target surface area.

The energy beam and stage manager 610, the surface roughness manager 615, and/or at least some of their various sub-components may be implemented in hardware, software executed by a processor, firmware, or any combination thereof. If implemented in software executed by a processor, the functions of the energy beam and stage manager 610, the surface roughness manager 615, and/or at least some of their various sub-components may be executed by a general-purpose processor, a digital signal processor (DSP), an application-specific integrated circuit (ASIC), a field-programmable gate array (FPGA), or other programmable logic device, discrete gate or transistor logic, discrete hardware components, or any combination thereof designed to perform the functions described in the present disclosure.

The energy beam and stage manager 610, the surface roughness manager 615, and/or at least some of their various sub-components may be physically located at various positions, including being distributed such that portions of functions are implemented at different physical locations by one or more physical devices. In some examples, the energy beam and stage manager 610, the surface roughness manager 615, and/or at least some of their various sub-components may be a separate and distinct component in accordance with various examples of the present disclosure. In other examples, the energy beam and stage manager 610, the surface roughness manager 615, and/or at least some of their various sub-components may be combined with one or more other hardware components, including but not limited to a receiver, a transmitter, a transceiver, one or more other components described in the present disclosure, or a combination thereof in accordance with various examples of the present disclosure.

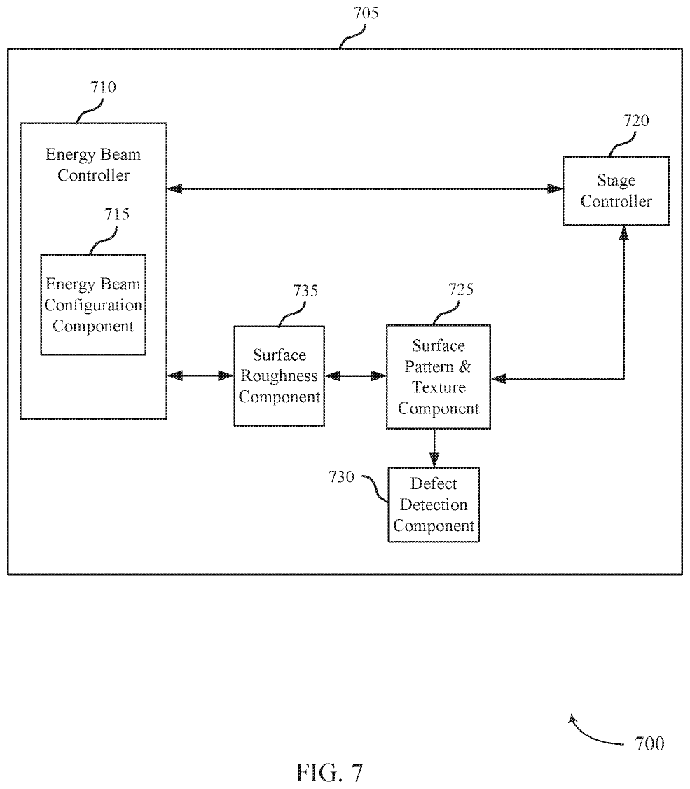

FIG. 7 shows an example block diagram 700 of a system 705 that supports surface modification by localized laser exposure in accordance with examples of the present disclosure. System 705 may be referred to as an electronic apparatus, and may be an example of a component of a controller for surface modification by localized laser exposure.

System 705 may include an energy beam controller 710, a stage controller 720, a surface pattern and texture component 725, a surface roughness component 735, and a defect detection component 730. These components may be in electronic communication with each other and may perform one or more of the functions described herein. In some cases, energy beam configuration component 715 may be a component of the energy beam controller 710. Energy beam controller 710 may be in electronic communication with the stage controller 720 and the surface roughness component. These components may also be in electronic communication with other components, both inside and outside of system 705, in addition to components not listed above, via other components, connections, or busses.

The energy beam controller 710 may be configured to transmit an energy beam toward the surface of the ceramic substrate via an energy emitter positioned adjacent to a substrate as described herein. For example, the energy beam controller 710 may be configured to heat the target surface area of the surface of a ceramic substrate until a surface roughness of the target surface area is within a predetermined range of the target surface roughness as described above. In some cases, the energy beam controller 710 may melt at least a portion of the target surface area until the surface roughness of the target surface area is within the predetermined range of the target surface roughness.

In some cases, the energy beam controller 710 may be configured to identify a depth of penetration of the surface of the ceramic substrate and transmit the energy beam based at least in part on the depth of penetration. In some cases, the energy beam controller 710 may be configured to transmit the energy beam based at least in part on the surface pattern or texture.

In some cases, the energy beam controller 710 may perform its operations using energy beam configuration component 715. For example, energy beam configuration component 715 may adjust one or more beam configuration parameters for the energy beam based at least in part on the measured friction coefficient and the target friction coefficient (on which the target surface roughness is based) and transmit the energy beam based at least in part on the adjusted one or more beam configuration parameters.

In some cases, the energy beam configuration component 715 may identify a beam configuration based at least in part on a set of texture characteristics and transmit a line laser beam or a point source laser beam in accordance with the beam configuration. In some examples, the energy beam configuration component 715 may set a beam configuration for the energy beam according to the target surface roughness and the target surface area and transmit the energy beam based at least in part on the beam configuration.

In some examples, the energy beam controller 710 may set a beam configuration for the energy beam, the beam configuration based at least in part on the target surface roughness, the target surface area, and a surface pattern and transmit the energy beam according to the beam configuration so as to modify the one or more outer faces of the ceramic substrate with the surface pattern. The energy beam controller 710 may also set a beam configuration for the energy beam, the beam configuration based at least in part on the target surface roughness, the target surface area, and a surface texture and transmit the energy beam according to the beam configuration so as to modify the one or more outer faces of the ceramic substrate with the surface texture.

In some examples, the energy beam controller 710 may set a beam configuration for the energy beam, the beam configuration based at least in part on the target surface roughness (which itself is based on a target friction coefficient), the target surface area, a beam power, a beam frequency, and a beam exposure duration and transmit the energy beam according to the beam configuration so as to modify the one or more outer faces of the ceramic substrate with at least the target surface roughness and the target surface area for the beam exposure duration. The energy beam controller 710 may also set a beam configuration for the energy beam, the beam configuration based at least in part on one or more of the target surface roughness, the target surface area, and the target friction coefficient and transmit the energy beam according to the beam configuration so as to modify the one or more outer faces of the ceramic substrate with the target friction coefficient.

In some cases, the energy beam controller 710 may set a beam configuration for the energy beam, the beam configuration based at least in part on one or more defects of the ceramic substrate and transmit the energy beam according to the beam configuration so as to correct the one or more defects in the one or more outer faces of the ceramic substrate.

In some cases, the energy beam controller 710 may be configured to move an energy emitter or an energy beam from the energy emitter with respect to an outer surface of a substrate.

The energy beam controller 710, or at least some of its various sub-components may be implemented in hardware, software executed by a processor, firmware, or any combination thereof. If implemented in software executed by a processor, the functions of the energy beam controller 710 and/or at least some of its various sub-components may be executed by a general-purpose processor, a DSP, an ASIC, an FPGA, or other programmable logic device, discrete gate or transistor logic, discrete hardware components, or any combination thereof designed to perform the functions described in the present disclosure.

The energy beam controller 710 and/or at least some of its various sub-components may be physically located at various positions, including being distributed such that portions of functions are implemented at different physical locations by one or more physical devices. In some examples, the energy beam controller 710 and/or at least some of its various sub-components may be a separate and distinct component in accordance with various examples of the present disclosure. In other examples, the energy beam controller 710 and/or at least some of its various sub-components may be combined with one or more other hardware components, including but not limited to a receiver, a transmitter, a transceiver, one or more other components described in the present disclosure, or a combination thereof in accordance with various examples of the present disclosure.

The stage controller 720 may be configured to rotate a stage supporting the ceramic substrate based at least in part on the target roughness and the target surface area, as described above. The stage controller 720, or at least some of its various sub-components may be implemented in hardware, software executed by a processor, firmware, or any combination thereof. If implemented in software executed by a processor, the functions of the stage controller 720 and/or at least some of its various sub-components may be executed by a general-purpose processor, a DSP, an ASIC, an FPGA or other programmable logic device, discrete gate or transistor logic, discrete hardware components, or any combination thereof designed to perform the functions described in the present disclosure.

The stage controller 720 and/or at least some of its various sub-components may be physically located at various positions, including being distributed such that portions of functions are implemented at different physical locations by one or more physical devices. In some examples, the stage controller 720 and/or at least some of its various sub-components may be a separate and distinct component in accordance with various examples of the present disclosure. In other examples, the stage controller 720 and/or at least some of its various sub-components may be combined with one or more other hardware components, including but not limited to a receiver, a transmitter, a transceiver, one or more other components described in the present disclosure, or a combination thereof in accordance with various examples of the present disclosure.

In some cases, the stage controller 720 may be in electronic communication with the surface pattern and texture component 725. The surface pattern and texture component 725 may identify a surface pattern or texture for the surface of the ceramic substrate.

The surface pattern and texture component 725 may be in electronic communication with the defect detection component 730. For example, the defect detection component 730 may determine one or more defects in the surface of the ceramic substrate and adjust the target roughness and the target surface area based at least in part on the one or more defects. In some cases, the energy beam controller 710 may heat the adjusted target surface area of the surface of the ceramic substrate until the surface roughness of the adjusted target surface area is within a correction range associated with the adjusted target roughness.

The energy beam controller 710 may be in electronic communication with the surface roughness component 735. For example, the surface roughness component 735 may identify a target surface roughness and a target surface area of the ceramic substrate to be modified to the target surface roughness. In some cases, the surface roughness component 735 may identify a target friction coefficient for the surface of the ceramic substrate and determine the target surface roughness and the target surface area based at least in part on the target friction coefficient. In some examples, the surface roughness component 735 may measuring a friction coefficient of the surface of the ceramic substrate after heating the target surface area.

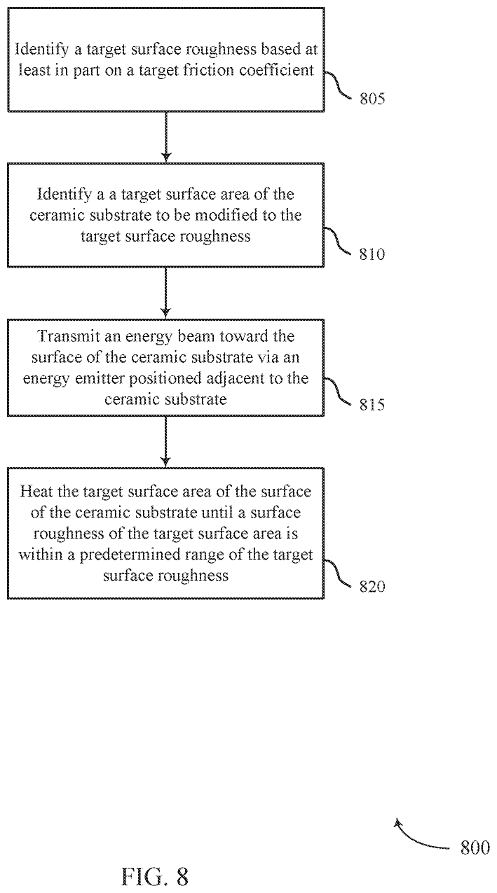

FIG. 8 illustrates a method 800 that supports surface modification by localized laser exposure in accordance with examples of the present disclosure. The operations of method 800 may be implemented by a device or its components as described herein. For example, the operations of method 800 may be performed by a system 605 and 705 as described with reference to FIGS. 6 and 7. In some examples, a device may execute a set of instructions to control the functional elements of the device to perform the functions described below. Additionally or alternatively, a device may perform aspects of the functions described below using special-purpose hardware.

At block 805, the method may include identifying a target surface roughness based at least in part on a target friction coefficient. The operations of 805 may be performed according to the methods described herein. In some examples, aspects of the operations of 805 may be performed by a surface roughness component as described with reference to FIG. 7.

At block 810, the method may include identifying a target surface area of the ceramic substrate to be modified to the target surface roughness. The operations of 810 may be performed according to the methods described herein. In some examples, aspects of the operations of 810 may be performed by a surface roughness component as described with reference to FIG. 7.

At block 815, the method may include transmitting an energy beam toward the surface of the ceramic substrate via an energy emitter positioned adjacent to the ceramic substrate. The operations of 815 may be performed according to the methods described herein. In some examples, aspects of the operations of 815 may be performed by an energy beam controller as described with reference to FIG. 7.

At block 820, the method may include heating the target surface area of the surface of the ceramic substrate until a surface roughness of the target surface area is within a predetermined range of the target surface roughness. The operations of 820 may be performed according to the methods described herein. In some examples, aspects of the operations of 820 may be performed by an energy beam controller as described with reference to FIG. 7.

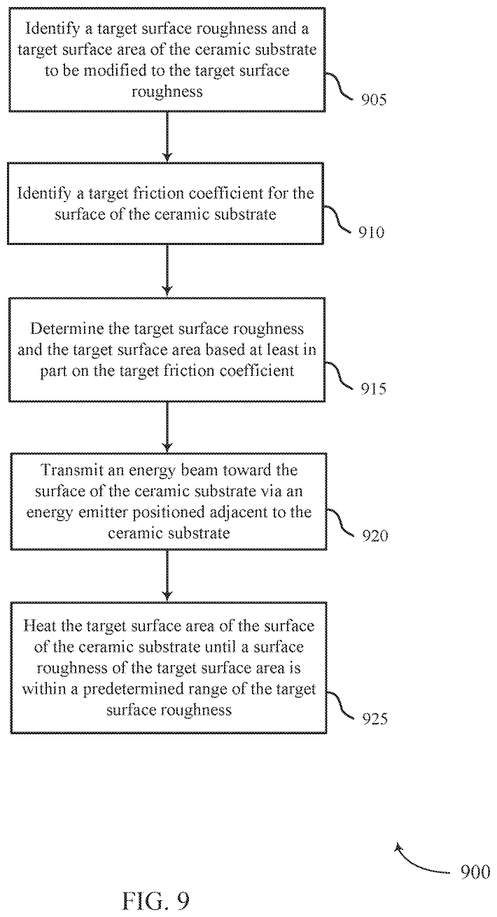

FIG. 9 illustrates a method 900 that supports surface modification by localized laser exposure in accordance with examples of the present disclosure. The operations of method 900 may be implemented by a device or its components as described herein. For example, the operations of method 900 may be performed by a system 605 and 705 as described with reference to FIGS. 6 and 7. In some examples, a device may execute a set of instructions to control the functional elements of the device to perform the functions described below. Additionally or alternatively, a device may perform aspects of the functions described below using special-purpose hardware.

At block 905, the method may include identifying a target surface roughness and a target surface area of the ceramic substrate to be modified to the target surface roughness. The operations of 905 may be performed according to the methods described herein. In some examples, aspects of the operations of 905 may be performed by a surface roughness component as described with reference to FIG. 7.

At block 910, the method may include identifying a target friction coefficient for the surface of the ceramic substrate. The operations of 910 may be performed according to the methods described herein. In some examples, aspects of the operations of 910 may be performed by a surface roughness component as described with reference to FIG. 7.

At block 915, the method may include determining the target surface roughness and the target surface area based at least in part on the target friction coefficient. The operations of 915 may be performed according to the methods described herein. In some examples, aspects of the operations of 915 may be performed by a surface roughness component as described with reference to FIG. 7.

At block 920, the method may include transmitting an energy beam toward the surface of the ceramic substrate via an energy emitter positioned adjacent to the ceramic substrate. The operations of 920 may be performed according to the methods described herein. In some examples, aspects of the operations of 920 may be performed by an energy beam controller as described with reference to FIG. 7.

At block 925, the method may include heating the target surface area of the surface of the ceramic substrate until a surface roughness of the target surface area is within a predetermined range of the target surface roughness. The operations of 925 may be performed according to the methods described herein. In some examples, aspects of the operations of 925 may be performed by an energy beam controller as described with reference to FIG. 7.

Thus, in some embodiments herein, the surface roughness of the outer surface can be adjust such as to affect the position or movement of the substrate within its mat or its can, which, in turn, may impact the efficiency of the catalytic converter.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for modifying a surface of a ceramic substrate, the method comprising:
identifying a target surface roughness based at least in part on a target friction coefficient;
identifying a target surface area of the ceramic substrate to be modified to the target surface roughness;
transmitting an energy beam toward the surface of the ceramic substrate via an energy emitter positioned adjacent to the ceramic substrate; and
heating the target surface area of the surface of the ceramic substrate until a surface roughness of the target surface area is within a predetermined range of the target surface roughness.

2. The method of claim 1, further comprising:
measuring a friction coefficient of the surface of the ceramic substrate after heating the target surface area;
adjusting one or more beam configuration parameters for the energy beam based at least in part on the measured friction coefficient and the target friction coefficient; and
transmitting the energy beam based at least in part on the adjusted one or more beam configuration parameters.

3. The method of claim 1, wherein heating the target surface area comprises:
melting at least a portion of the target surface area until the surface roughness of the target surface area is within the predetermined range of the target surface roughness.

4. The method of claim 1, further comprising:
identifying a depth of penetration of the surface of the ceramic substrate; and
transmitting the energy beam based at least in part on the depth of penetration.

5. The method of claim 1, further comprising:
identifying a surface pattern or texture for the surface of the ceramic substrate; and
transmitting the energy beam based at least in part on the surface pattern or texture.

6. The method of claim 1, further comprising:
determining one or more defects in the surface of the ceramic substrate;
adjusting the target roughness and the target surface area based at least in part on the one or more defects; and
heating the adjusted target surface area of the surface of the ceramic substrate until the surface roughness of the adjusted target surface area is within a correction range associated with the adjusted target roughness.

7. The method of claim 1, further comprising:
rotating a stage supporting the ceramic substrate based at least in part on the target roughness and the target surface area.

8. The method of claim 1, wherein transmitting the energy beam comprises:
identifying a beam configuration based at least in part on a set of texture characteristics; and
transmitting a line laser beam or a point source laser beam in accordance with the beam configuration.

9. The method of claim 1, further comprising:
setting a beam configuration for the energy beam according to the target surface roughness and the target surface area; and
transmitting the energy beam based at least in part on the beam configuration.

10. A system comprising:
a rotatable stage having a portion configured to support a ceramic substrate having two opposing ends and one or more outer faces extending between the two opposing ends; and
an energy emitter positioned adjacent to the ceramic substrate supported by the rotatable stage, the energy emitter configured to transmit an energy beam toward the one or more outer faces of the ceramic substrate so as to modify a surface roughness of the one or more outer faces in accordance with at least a target surface area and a target surface roughness based at least in part on a target friction coefficient.

11. The system of claim 10, further comprising:
the ceramic substrate comprising a porous ceramic material and positioned on the rotatable stage, wherein the surface roughness of the one or more outer faces is different from the target surface roughness.

12. The system of claim 11, wherein a total surface area of the one or more outer faces is greater than the target surface area.

13. The system of claim 10, further comprising:
a controller to control transmission of the energy beam via the energy emitter according to a set of surface processing parameters comprising at least the target surface roughness and the target surface area.

14. The system of claim 13, wherein the controller is configured to:
set a beam configuration for the energy beam, the beam configuration based at least in part on the target surface roughness, the target surface area, and a surface pattern; and
transmit the energy beam according to the beam configuration so as to modify the one or more outer faces of the ceramic substrate with the surface pattern.

15. The system of claim 13, wherein the controller is configured to:
set a beam configuration for the energy beam, the beam configuration based at least in part on the target surface roughness, the target surface area, and a surface texture; and
transmit the energy beam according to the beam configuration so as to modify the one or more outer faces of the ceramic substrate with the surface texture.

16. The system of claim 13, wherein the controller is configured to:
set a beam configuration for the energy beam, the beam configuration based at least in part on the target surface roughness, the target surface area, a beam power, and a beam exposure duration; and
transmit the energy beam according to the beam configuration so as to modify the one or more outer faces of the ceramic substrate with at least the target surface roughness and the target surface area for the beam exposure duration.

17. The system of claim 13, wherein the controller is configured to:
set a beam configuration for the energy beam, the beam configuration based at least in part on one or more of the target surface roughness, the target surface area, and the target friction coefficient; and
transmit the energy beam according to the beam configuration so as to modify the one or more outer faces of the ceramic substrate with the target friction coefficient.

18. The system of claim 13, wherein the controller is configured to:
set a beam configuration for the energy beam, the beam configuration based at least in part on one or more defects of the ceramic substrate; and
transmit the energy beam according to the beam configuration so as to correct the one or more defects in the one or more outer faces of the ceramic substrate.

19. The system of claim 10, further comprising:
a rotation controller configured to rotate the ceramic substrate via the rotatable stage according to a set of surface processing parameters comprising at least the target surface roughness and the target surface area.

20. The system of claim 10, wherein the energy emitter comprises a laser source, the laser source configured to:
transmit a line laser beam or a point source laser beam in accordance with a beam configuration.

21. The system of claim 20, wherein the beam configuration is associated with a surface pattern or a surface texture for the one or more outer faces of the ceramic substrate.
